(19) United States
(12) Patent Application Publication
(10) Pub. No.: US 2017/0344729 A1
(43) Pub. Date: Nov. 30, 2017

(54) SYSTEMS AND METHODS FOR IDENTITY AUTHENTICATION USING SOFTWARE LICENSES

(71) Applicant: MasterCard International Incorporated, Purchase, NY (US)

(72) Inventor: Manoneet Kohli, O'Fallon, MO (US)

(21) Appl. No.: 15/165,845

(22) Filed: May 26, 2016

(51) Int. Cl. G06F 21/10; G06Q 20/32; G06Q 20/40

(52) U.S. Cl. CPC G06F 21/105; G06Q 20/4016; G06Q 20/3224; G06Q 20/4014

(57) ABSTRACT

An authentication computing device for authenticating user identity using software license information is provided herein. The authentication computing device is configured to store a list of merchants that provide software licenses, and receive an authentication request associated with a transaction initiated using a payment card at a user computing device for a subsequent software license. The authentication request includes transaction information. The authentication computing device is also configured to determine that a merchant associated with the transaction is included in the list of merchants. The authentication computing device is further configured to determine whether a card type of the payment card satisfies card criteria, and determine whether a location of the user computing device satisfies location criteria. The authentication computing device is also configured to, when card criteria and location criteria are satisfied, transmit an authentication response including an indicator that the user of the user computing device is authenticated.

### BACKGROUND OF THE DISCLOSURE

This invention relates generally to authenticating a user of a computing device and, more particularly, to network-based systems and methods for providing authenticating a user of a computing device based on a previous grant of a software license to the user computing device.

Users of computing devices oftentimes purchase software online for operating on their computing device. For example, a user may purchase and download an anti-virus software for protecting their computer from virus or other computer-related attacks. As another example, a user may download a time-limited and/or feature-limited trial version of a software program, such as a word processing or image editing software. In at least some of these cases, the user must provide certain information in order to be granted an “initial” software license for the software, for example, prior to purchasing and/or downloading the software. In some cases, a purchase of the software is made using a payment card. In at least some cases, the initial software license is “bound” to the user computing device at which the software the software is downloaded and/or installed. This license-binding uniquely identifies the license owner (e.g., a user of the user computing device) and is used to track the validity and usage of the license.

Many of these software products require upgrades (e.g., yearly, or after expiration of the version) and/or subscriptions (e.g., monthly), so a renewal or “subsequent” software license must be purchased each time the upgrade is downloaded or the subscription fee is paid. In some known systems, when the subsequent software license is purchased, the user must re-enter their payment card information and/or additional user information, and the system must re-authenticate the user. Re-authentication can take time and money. Moreover, in at least some known systems, these authentication processes require the user to provide additional information, such as a particular code or the answer to a security question. This can be an annoyance or inconvenience to the user, and increases the chances of the transaction being abandoned by the user.

### BRIEF DESCRIPTION OF THE DISCLOSURE

In one aspect, an authentication computing device for authenticating a user of a user computing device using software license information is provided. The authentication computing device includes a processor in communication with a memory. The processor is programmed to store a list of merchants that provide software licenses. The processor is also programmed to receive an authentication request, wherein the authentication request is associated with a transaction initiated using a payment card at the user computing device for a subsequent software license. The subsequent software license is associated with an initial software license, and the authentication request includes transaction information. The processor is further programmed to determine, using the transaction information, that a merchant associated with the transaction is included in the list of merchants that provide software licenses. The processor is also programmed to determine, using the transaction information, whether a card type of the payment card satisfies card criteria, and determine, using the transaction information, whether a location of the user computing device satisfies location criteria. The processor is still further programmed to, when the card criteria and the location criteria are satisfied, transmit an authentication response including an indicator that the user of the user computing device is authenticated.

In another aspect, a computer-implemented method for authenticating a user of a user computing device using software license information is provided. The method is implemented using an authentication computer device including a processor and a memory. The method includes storing a list of merchants that provide software licenses. The method also includes receiving an authentication request, wherein the authentication request is associated with a transaction initiated using a payment card at the user computing device for a subsequent software license. The subsequent software license is associated with an initial software license, and the authentication request includes transaction information. The method further includes determining, using the transaction information, that a merchant associated with the transaction is included in the list of merchants that provide software licenses. The method also includes determining, using the transaction information, whether a card type of the payment card satisfies card criteria, and determining, using the transaction information, whether a location of the user computing device satisfies location criteria. The method still further includes, when the card criteria and the location criteria are satisfied, transmitting an authentication response including an indicator that the user of the user computing device is authenticated.

In yet another aspect, at least one non-transitory computer-readable storage media having computer-executable instructions embodied thereon, for authenticating a user of a user computing device using software license information, is provided. When executed by at least one processor, the computer-executable instructions cause the processor to store a list of merchants that provide software licenses. The computer-executable instructions also cause the processor to receive an authentication request, wherein the authentication request is associated with a transaction initiated using a payment card at the user computing device for a subsequent software license. The subsequent software license is associated with an initial software license, and the authentication request includes transaction information. The computer-executable instructions further cause the processor to determine, using the transaction information, that a merchant associated with the transaction is included in the list of merchants that provide software licenses. The computer-executable instructions also cause the processor to determine, using the transaction information, whether a card type of the payment card satisfies card criteria, and determine, using the transaction information, whether a location of the user computing device satisfies location criteria. The computer-executable instructions still further cause the processor to, when the card criteria and the location criteria are satisfied, transmit an authentication response including an indicator that the user of the user computing device is authenticated.

### BRIEF DESCRIPTION OF THE DRAWINGS

FIGS. 1-6 show example embodiments of the methods and systems described herein.

FIG. 1 is a simplified block diagram of an example secure identification system for authenticating a user of a user computing device during a card-not-present transaction associated with a software license.

FIG. 2 illustrates an example configuration of a user system of the secure identification system shown in FIG. 1.

FIG. 3 illustrates an example configuration of a server system of the secure identification system shown in FIG. 1.

FIG. 4 is a diagram illustrating the flow of information between components of the secure identification system shown in FIG. 1.

FIG. 5 is an example method for authenticating a user of a user computing device using software license information using, for example, the secure identification system shown in FIG. 1.

FIG. 6 shows an example configuration of a database within a computing device, along with other related computing components, that may be used to authenticate user identity using software license information.

Like numbers in the Figures indicate the same or functionally similar components.

### DETAILED DESCRIPTION OF THE DISCLOSURE

Systems and methods are described herein for evaluating payment card transactions for fraud. In one aspect, systems and methods are provided for authenticating user identity using software license information. A secure identification system described herein is configured to authenticate a user's identity using software licensing information. In particular, the secure identification system is configured to leverage information generated in association with an initial software license to authenticate a transaction association with a purchase of a subsequent software license. The secure identification system includes an authentication computing device including a processor and a memory. In the example embodiment, the authentication computing device is associated with, in communication with, and/or integral to a payment processor configured to process transactions initiated by cardholders using payment cards (e.g., credit cards, debit card, prepaid cards, etc.). During at least some transactions initiated with a payment card, at least one party to the transaction (e.g., the merchant, merchant bank, or issuer of the payment card) will initiate an authentication process. The authentication process is designed to prevent fraudulent transactions by authenticating the identity of the cardholder. At least one such authentication process is the 3-D Secure® (3DS) protocol, which is implemented using authentication services like MasterCard SecureCode® (3-D Secure is a registered trademark of Visa International Service Association, Delaware; MasterCard SecureCode is a registered trademark of MasterCard International Incorporated, Purchase, N.Y.).

Various authentication processes may be performed by various parties. For example, in some cases, at least one of the merchant, merchant bank, and/or issuer will perform their own authentication. In other cases, the party that initiates the authentication may contract with another party that provides the authentication service (which may be, for example, one of the merchant bank or issuer, or may be a transaction processing network, or may be another third party). Upon authentication of the cardholder's identity, the authentication service provides an indication of authentication (sometimes with a score or level of confidence) to the authentication-initiating party. The transaction may then be resumed and transmitted for an authorization process. The payment processor collects transaction data associated with these transactions (e.g., authentication and/or authorization) for further processing.

In some situations such as in-store credit card purchases, the issuer of the credit card typically assumes liability for certain aspects of the transaction, such as chargebacks. In other situations, such as online transactions through a merchant web site, the merchant party in the transaction assumes initial liability for certain aspects of the transaction unless, for example, certain risk-mitigating steps are taken, such as an authentication step. For example, some known payment networks engage an authentication service such as a 3-D Secure service that performs an authentication of a consumer prior to authorization of the transaction. During some known 3-D Secure transactions, the consumer is presented with an authentication challenge, sometimes called a “step-up challenge.” This step-up challenge generally requires the suspect consumer to provide a password, or a passcode from a second factor user device, before the transaction will be processed. This extra step presents an interruptive inconvenience, barrier, or an interference to at least some legitimate consumers, and subsequently causes at least some consumers to abandon legitimate transactions. These abandonments results in lost revenues to both the merchant and the issuer.

In the example embodiment, the authentication computing device is associated with an authentication service. As described above, the authentication service may be provided to merchants, merchant banks, and/or issuers by a transaction processing network and/or by another third party. The authentication computing device is further in communication with a plurality of merchant computing devices, wherein a subset of the plurality of merchant computing devices are each associated with a respective merchant known to provide software-licensing services. In one embodiment, the authentication computing device may store, receive, retrieve, and/or otherwise access a lookup table including the plurality of merchant computing devices, wherein the lookup table indicates whether or not each of the plurality of merchant computing devices is associated with a merchant that provides software-licensing services.

In one embodiment, each merchant that provides software-licensing services collects licensee information during the grant of an initial software license. In some cases, the grant of an initial software license may include the purchase or download of a temporary software license (e.g., a license that expires after a certain interval) or a “basic” software license (e.g., a license for a software package that includes some but not all premium software features). The licensee information associates the particular software license granted to the machine and/or user of the machine to which access to the software is granted. Licensee information may include, for example, device information, payment card information, and/or digital wallet information. Device information may include information about the computing device used during the transaction, such as a unique hardware identifier, or an IP or MAC address associated with the device. Payment card information may include information about the payment card or the cardholder, such as a type of payment card used, payment credentials (e.g., payment card information), an expiration date of the payment card, or a name or a billing address of the cardholder. Digital wallet information may include information about a digital wallet used during the transaction, such as how the cardholder was authenticated into the digital wallet (e.g., an access code or method), whether the digital wallet has historically been used with the current computing device, or whether the shipping address of the current transaction is a shipping address previously used with the digital wallet. The merchant may also record initial license expiry information indicating when the initial license is to expire or will no longer be valid, and/or when the licensee of the initial license may be eligible for a subsequent software license (e.g., upgrade to a premium license, the next installment of a recurring license, etc.).

In the example embodiment, the authentication computing device receives an authentication request associated with a transaction initiated in connection with a subsequent software license. The authentication computing device may receive the authentication request from a merchant computing device, a computing device associated with the merchant bank, a computing device associated with an issuer, etc. The authentication computing device determines the merchant associated with the transaction and accesses the lookup table to determine whether the merchant provides software licenses. If the merchant does provide software licenses, the authentication computing device performs authentication of the cardholder initiating the purchase of the subsequent software license using data elements included in the authentication request (e.g., transaction information).

In one embodiment, the authentication computing device uses data elements in the transaction information to determine if the transaction satisfies card criteria and location criteria. “Card criteria” include specific authentication rules associated with the payment card used to initiate the transaction. In one embodiment, to satisfy card criteria, the card type of the payment card must have permission to initiate the transaction. For example, corporate or business cards may have permissions to initiate transaction for certain software licenses but not for other. The authentication computing device determines whether the card type of the payment card has permission to purchase the software license, and, if so, the transaction satisfies the card criteria. If the authentication computing device determines that the transaction does not satisfy the card criteria, the authentication computing device may not authenticate the transaction. Additionally or alternatively, the authentication computing device may transmit an authentication response to the merchant and/or the issuer indicating that the transaction does not satisfy the card criteria (e.g., that the payment card does not have permission to make the transaction). Card criteria may include other authentication rules without departing from the scope of the present disclosure.

“Location criteria” include specific authentication rules associated with the user computing device at which the transaction is initiated. In one embodiment, to satisfy location criteria, the user computing device must not be located in a high-risk country. The authentication computing device determines a location of the user computing device (e.g., using an IP address or other location identifier included in the authentication request) and consults a list of high-risk country codes. The list of high-risk country codes is pre-populated with country codes associated with countries for which the risk of fraud is relatively high (e.g., China, India, Russia). The list of high-risk country codes may be updated by the authentication computing device and/or by an external computing device (e.g., an update server, not shown) in accordance with increasing or decreasing risk in various countries. If the location of the user computing device does not correspond to any of the high-risk country codes, the authentication computing device determines that the transaction satisfies the location criteria. If the authentication computing device determines that the transaction does not satisfy the location criteria, the authentication computing device may not authenticate the transaction. Additionally or alternatively, the authentication computing device may transmit an authentication response to the merchant and/or the issuer indicating that the transaction does not satisfy the location criteria (e.g., that the transaction was initiated at a user computing device in a high-risk location). Location criteria may include other authentication rules without departing from the scope of the disclosure.

If the authentication computing device determines that the transaction (i) is associated with a merchant known to provide software licenses, (ii) satisfies card criteria, and (iii) satisfied location criteria, the authentication computing device transmits an authentication response to the merchant and/or issuer indicating that the authentication of the user of the user computing device was successful. In one embodiment, if the merchant receives the authentication response indicating that the transaction was authenticated, the merchant computing device may then proceed with the authorization process for the transaction. The issuer may also accept the authentication and choose to proceed with the authorization process for the transaction. In the example embodiment, the merchant computing device (and/or the issuer computing device) may bypass any additional authentication procedure (e.g., 3-D Secure®) based upon the successful authentication by the authentication computing device. Accordingly, cardholder inconveniences may be reduced and fewer transactions may be abandoned. In certain embodiments in which the authentication services of the authentication computing device are performed on behalf of a merchant or merchant bank (e.g., the merchant or merchant bank subscribes to the authentication service), liability for the transaction may remain with the merchant. In other embodiments in which the authentication services are performed on behalf of an issuer, liability for the transaction may shift to the issuer when the transaction proceeds through authorization.

In some embodiments, the authentication request also includes a flag generated and appended to the authentication request by the merchant. The flag includes an indicator that the merchant has already performed at least some measures of in-house verification and/or authentication of the user initiating the transaction. In one embodiment, this in-house authentication includes matching one or more data elements or “user credentials” between the grant of the initial software license and the transaction involving the subsequent software license. For example, the flag may indicate that the merchant has determined that the same card type (or card with the same number) is being used to initiate the purchase of the subsequent software license, that the cardholder is initiating the purchase from the same IP address, and/or any other authentications or validations.

In some embodiments, if the authentication process is unsuccessful, the authentication computing device transmits (or otherwise causes display of) a prompt to the cardholder to enter additional authentication information. Additional authentication information may include, for example, a password, a response to a security question, and/or any other information suitable for authentication of the cardholder. In other embodiments, the authentication computing device performs no additional authentication. In any embodiment, the authentication computing device transmits the authentication response indicating to the merchant computing device the results of any and all authentication processes performed. The merchant computing device may process the authentication response and determine whether to decline the transaction or proceed with the authorization process for the transaction. If the merchant computing device determines to proceed with the authorization process for the transaction, the merchant computing device transmits an authorization request message to the issuer bank. The authorization request message may additionally include the indication(s) of the results of the authentication processes performed by the authentication computing device. The issuer may refuse to authorize the transaction based on the unsuccessful authentication.

In some embodiments, the authentication computing device transmits the authentication response (whether the authentication was successful or unsuccessful) to the merchant and/or issuer computing device via an extension message to the 3DS protocol. For example, the authentication computing device may provide an indication of whether the authentication was successful or unsuccessful by embedding an XML-formatted message as a 3DS extension during the authentication process. In some embodiments, the authentication computing device may share individual risk-based data elements used to determine whether the authentication was successful or unsuccessful, such as which criteria were satisfied.

At least one of the technical problems addressed by this system includes: (i) high network load based at least in part on step-up challenging most or all card-not-present transactions which results in network delays, reduced bandwidth, and/or low throughput; (ii) consumer inconvenience during card-not-present transactions based at least in part on having to answer an additional authentication challenge during a transaction; and/or (iii) abandonment of transactions by consumers when faced with a step-up challenge, thus leading to lost sales for merchants and lost processing fees for the other network parties based on those abandoned transactions.

The systems and methods described herein are configured to solve problems arising in the computer network area. More specifically, the systems and methods described herein are configured to solve problems arising in the transaction processing industry, such as the difficulty in authenticating card-not-present (CNP) transactions, such as online transactions. Authentication issues associated with CNP transactions are rooted in the computer network area, as such issues did not arise and/or were not relevant prior to the advent of computer processing of financial transactions. The transactions associated with software licenses, described herein, are most commonly performed online in such CNP transactions. The authentication computing device provides a “truncated” authentication process requiring little, if any, personally identifiable information (e.g., only a card type and location identifier, which may be country- or state-level) to be sent to the authentication computing device in order to successfully authenticate the user. The authentication processes and systems described herein provide (i) improved transactions processing speeds and/or throughput due to enhanced and software transaction-specific authentication processes; (ii) improved security in CNP, software licensing purchases and/or other transactions; (iii) reduction in the amount of network and computing resources needed to reduce the number of fraudulent transactions processed by the payment network; (iv) reduction in the number of fraudulent transactions being processed; (v) reduction in consumer inconvenience during card-not-present transactions; (vi) reduction in the number of transactions that are abandoned by consumers when faced with an additional authentication challenge, and thus reducing lost sales for the merchant and reducing lost fees for the other network parties based on those abandoned transactions; and/or (vii) a risk-based decisioning service to merchants, merchant acquirers, and/or issuers.

A technical effect of the systems and processes described herein is achieved by performing at least one of the following steps: (i) storing a list of merchants that provide software licenses; (ii) receiving an authentication request, wherein the authentication request is associated with a transaction initiated using a payment card at a user computing device for a subsequent software license, the subsequent software license associated with an initial software license, and wherein the authentication request includes transaction information; (iii) determining, using the transaction information, that a merchant associated with the transaction is included in the list of merchants that provide software licenses; (iv) determining, using the transaction information, whether a card type of the payment card satisfies card criteria; (v) determining, using the transaction information, whether a location of the user computing device satisfies location criteria; and (vi) when the card criteria and the location criteria are satisfied, transmitting an authentication response including an indicator that the user of the user computing device is authenticated.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In one embodiment, a computer program is provided, and the program is embodied on a computer readable medium. In an example embodiment, the system is executed on a single computer system, without requiring a connection to a sever computer. In a further embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, digital wallets, and/or computers. Each type of transactions card can be used as a method of payment for performing a transaction. As used herein, the term “payment account” is used generally to refer to the underlying account with the transaction card. In addition, cardholder card account behavior can include but is not limited to purchases, management activities (e.g., balance checking), bill payments, achievement of targets (meeting account balance goals, paying bills on time), and/or product registrations (e.g., mobile application downloads).

As used herein, the term “authentication” (or an “authentication process”) is used generally to refer to a process conducted on a payment transaction prior to the “authorization” of a transaction (or an “authorization process”). At least one purpose of the authentication process is to evaluate whether or not the person conducting the transaction is actually a person privileged to use the payment card presented in the transaction. An authentication process may be used to reduce fraudulent transactions, and thus protect one or more parties to the transaction (e.g., the merchant, or the issuer of the payment card).

The following detailed description illustrates embodiments of the disclosure by way of example and not by way of limitation. It is contemplated that the disclosure has general application to processing financial transaction data by a third party in industrial, commercial, and residential applications.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

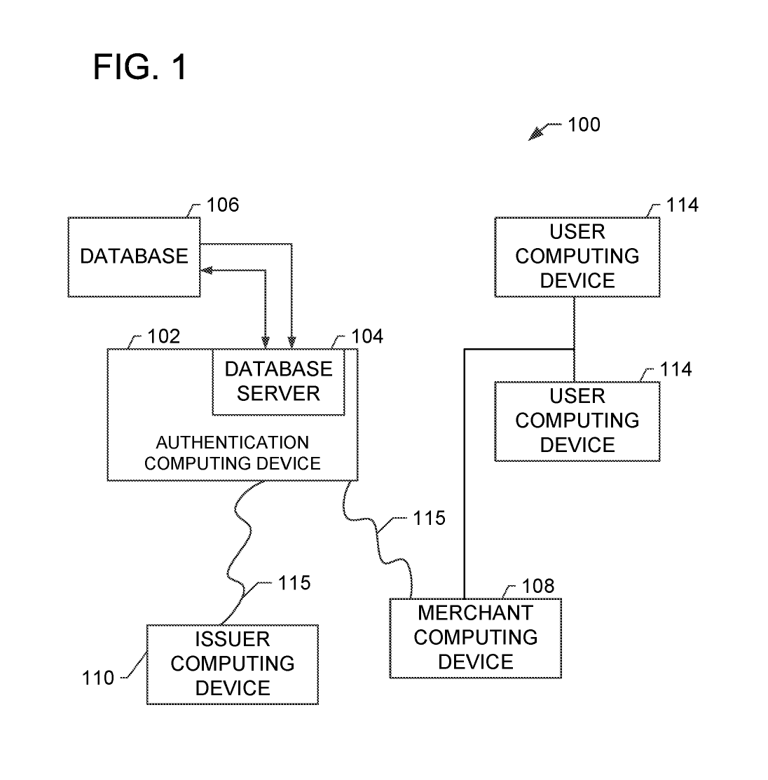

FIG. 1 is a simplified block diagram of an example secure identification system 100 for authenticating a user of a user computing device 114 during a transaction. In the example embodiment, secure identification system 100 includes a plurality of computer devices connected in communication in accordance with the present disclosure. More specifically, secure identification system 100 includes an authentication computing device 102, at least one merchant computing device 108 associated with a merchant and/or a merchant bank, and at least one issuer computing device 110 associated with an issuer. In a typical transaction card system, a financial institution called the “issuer” issues a transaction card, such as a credit card, to a consumer or cardholder, who uses the transaction card to tender payment for a purchase from a merchant. To accept payment with the transaction card, the merchant must normally establish an account with a financial institution that is part of the financial payment system. This financial institution is usually called the “merchant bank,” the “acquiring bank,” or the “acquirer.” When the cardholder tenders payment for a purchase with a transaction card, the merchant requests authorization from a merchant bank for the amount of the purchase, for example, by receiving account information associated with the cardholder and communicating the account information to the merchant bank. Using a payment processor, the merchant will communicate with the issuer bank to determine whether the cardholder's account is in good standing and whether the purchase is covered by the cardholder's available credit line. Based on these determinations, the request for authorization will be declined or accepted. If a request for authorization is accepted, the available credit line of the cardholder's account is decreased. If the cardholder uses a debit card, the available funds in the cardholder's account will be decreased. The payment processor may store the transaction card information, such as a type of merchant, amount of purchase, date of purchase, in a database (e.g., database 106).

After a purchase has been made, a clearing process occurs to transfer additional transaction data related to the purchase among the parties to the transaction. More specifically, during and/or after the clearing process, additional data, such as a time of purchase, a merchant name, a type of merchant, purchase information, account-holder account information, a type of transaction, savings information, information regarding the purchased item and/or service, and/or other suitable information, is associated with a transaction and transmitted between parties to the transaction as transaction data. Payment processor 108 may store the transaction data in database 106.

At least one client system 114 (also referred to as user computing devices 114) is in communication with merchant computing device 108. User computing devices 114 are associated with consumers or cardholders. Additionally or alternatively, one or more user computing devices 114 may be associated with merchants, merchant banks, and/or issuers. User computing devices 114 could be any device capable of interconnecting to the Internet including a web-based phone, PDA, tablet, personal computer, or other web-based connectable equipment. In the example embodiment, user computing devices 114 are sources of one or more card-not-present (CNP) transactions initiated in connection with a software license, offered by a merchant, as described further herein. At least some components of secure identification system 100 are interconnected to the Internet through many interfaces including a network 115, such as a local area network (LAN) or a wide area network (WAN), dial-in-connections, cable modems, special high-speed Integrated Services Digital Network (ISDN) lines, and RDT networks.

Additionally, a database server 104 is connected to a database 106, which contains information on a variety of matters, as described below in greater detail. In one embodiment, centralized database 106 is stored on authentication computing device 102. In an alternative embodiment, database 106 is stored remotely from authentication computing device 102 and may be non-centralized. Database 106 may include a single database having separated sections or partitions or may include multiple databases, each being separate from each other. Database 106 may store transaction data generated as part of sales activities and savings activities conducted over the processing network including data relating to merchants, account holders or customers, issuers, acquirers, savings amounts, savings account information, and/or purchases made. Database 106 may also store one or more lists of merchants or merchant types, specifically at least one list identifying a plurality of merchants that are associated with (e.g., offer for sale) software licenses. Database 106 may also store other merchant data including merchant identifiers. Database 106 may also store information associated with transaction processing risks, such as high-risk country codes associated with countries in which the risk of fraud is high.

Authentication computing device 102 receives an authentication request message (i.e., a request for the identity authentication services provided by authentication computing device 102) from merchant computing device 108. The authentication request message is associated with a transaction initiated in connection with a subsequent software license. The subsequent software license is associated with an initial software license, which was obtained at a previous date or time. The initial software license and subsequent software license are made available (e.g., for sale or download) by a merchant, and that merchant is associated with merchant computing device 108. Authentication computing device 102 may additionally or alternatively receive an authentication request message from issuer computing device 110 and/or any other party associated with the transaction. The authentication request message includes information associated with the transaction, such as location information (e.g., a geographic location or IP address of the user computing device 114 at which the transaction originated), certain payment details (e.g., a payment card type, payment card number, account identifier, etc.), cardholder details (e.g., a billing address or country code), and/or additional information.

Authentication computing device 102 determines whether the merchant associated with the transaction is a merchant associated with providing software licenses. If so, the authentication computing device 102 initiates further authentication of the user of the user computing device. According to authentication rules, authentication computing device 102 authenticates or does not authenticate the user computing device 114 (and, thereby, the user thereof) associated with the transaction. For example, authentication computing device 102 may determine, using transaction information included in the authentication request, whether the transaction meets card criteria and/or location criteria. Authentication computing device 102 transmits an authentication response message to the merchant computing device 108 (and/or other computing device) from which authentication computing device 102 received the authentication request message. The authentication response message includes an indicator of whether the authentication was successful or unsuccessful. One or more parties to the transaction may respond to the indicator by allowing the transaction to proceed to authorization and/or by refusing the transaction.

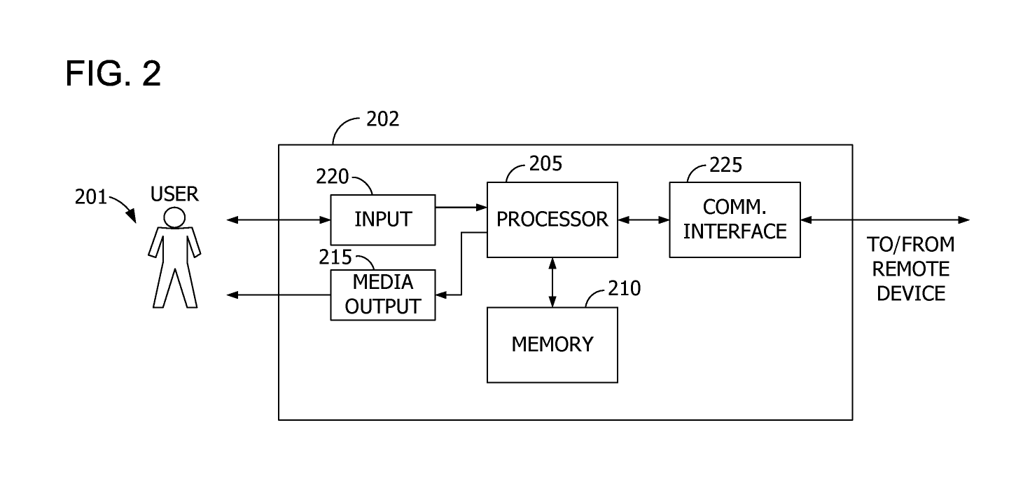

FIG. 2 illustrates an example configuration of a user system 202 operated by a user 201. In some embodiments, user system 202 is a merchant system and/or a merchant POS device. In other embodiment, user system 202 is a user computing device 114 (shown in FIG. 1). In the example embodiment, user system 202 includes a processor 205 for executing instructions. In some embodiments, executable instructions are stored in a memory area 210. Processor 205 may include one or more processing units, for example, a multi-core configuration. Memory area 210 is any device allowing information such as executable instructions and/or written works to be stored and retrieved. Memory area 210 may include one or more computer readable media.

User system 202 also includes at least one media output component 215 for presenting information to user 201. Media output component 215 is any component capable of conveying information to user 201. In some embodiments, media output component 215 includes an output adapter such as a video adapter and/or an audio adapter. An output adapter is operatively coupled to processor 205 and operatively couplable to an output device such as a display device, a liquid crystal display (LCD), organic light emitting diode (OLED) display, or “electronic ink” display, or an audio output device, a speaker or headphones.

In some embodiments, user system 202 includes an input device 220 for receiving input from user 201. Input device 220 may include, for example, a keyboard, a pointing device, a mouse, a stylus, a touch sensitive panel, a touch pad, a touch screen, a gyroscope, an accelerometer, a position detector, or an audio input device. A single component such as a touch screen may function as both an output device of media output component 215 and input device 220. User system 202 may also include a communication interface 325, which is communicatively couplable to a remote device such as authentication computing device 102 (shown in FIG. 1). Communication interface 225 may include, for example, a wired or wireless network adapter or a wireless data transceiver for use with a mobile phone network, Global System for Mobile communications (GSM), 3G, or other mobile data network or Worldwide Interoperability for Microwave Access (WIMAX).

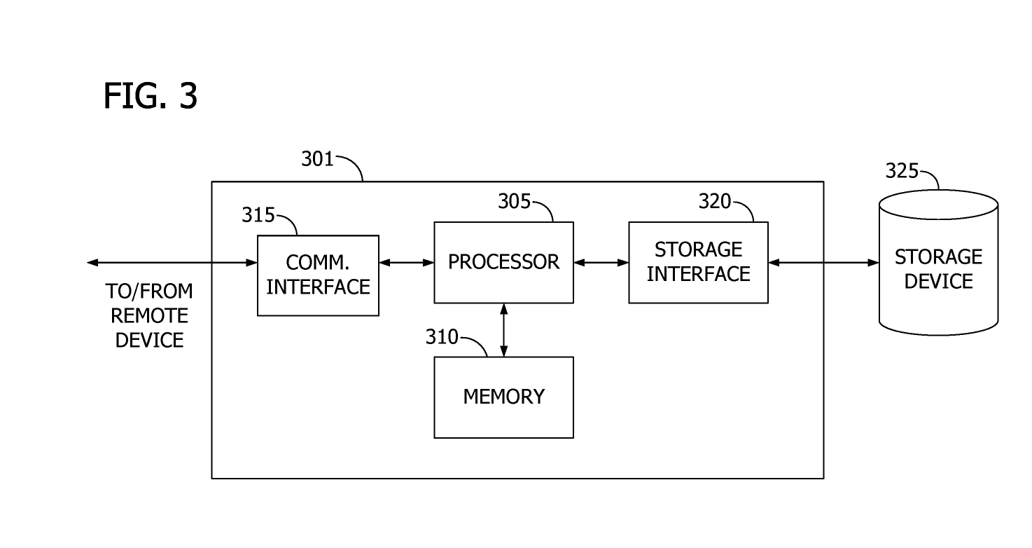

Stored in memory area 210 are, for example, computer readable instructions for providing a user interface to user 201 via media output component 215 and, optionally, receiving and processing input from input device 220. A user interface may include, among other possibilities, a web browser and client application. Web browsers enable users, such as user 201, to display and interact with media and other information typically embedded on a web page or a website from a server system (e.g., server system 301, shown in FIG. 3). A client application or “app” allows user 201 to interact with a server application from server system 301.

In the example embodiment, computing device 202 is a user computing device from which user 201 uses a payment card and/or a digital wallet to engage with an online merchant, a network, and an issuer of a payment card to perform a transaction which undergoes a user identity authentication process, as described herein.

FIG. 3 illustrates an example configuration of a server system 301 such as authentication computing device 102 (shown in FIG. 1). Server system 301 may additionally or alternatively include, but is not limited to, database server 104, merchant computing device 108, and/or issuer computing device 110 (all shown in FIG. 1).

Server system 301 includes a processor 305 for executing instructions. Instructions may be stored in a memory area 310, for example. Processor 305 may include one or more processing units (e.g., in a multi-core configuration) for executing instructions. The instructions may be executed within a variety of different operating systems on the server system 301, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 305 is operatively coupled to a communication interface 315 such that server system 301 is capable of communicating with a remote device such as user system 202 (shown in FIG. 2) or another server system 301. For example, communication interface 315 may receive requests from merchant computing device 108 via the Internet, as illustrated in FIG. 1.

Processor 305 may also be operatively coupled to a storage device 325. Storage device 325 is any computer-operated hardware suitable for storing and/or retrieving data. In some embodiments, storage device 325 is integrated in server system 301. For example, server system 301 may include one or more hard disk drives as storage device 325. In other embodiments, storage device 325 is external to server system 301 and may be accessed by a plurality of server systems 301. For example, storage device 325 may include multiple storage units such as hard disks or solid state disks in a redundant array of inexpensive disks (RAID) configuration. Storage device 325 may include a storage area network (SAN) and/or a network attached storage (NAS) system.

In some embodiments, processor 305 is operatively coupled to storage device 325 via a storage interface 320. Storage interface 320 is any component capable of providing processor 305 with access to storage device 325. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 325.

Memory area 310 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

In one embodiment, server system 301 is authentication computing device 102 in communication with one or more of merchant computing device 108 and issuer computing device 110 during a payment card transaction initiated in connected with a subsequent software license. Authentication computing device 102 performs authentication of the transaction using transaction information. Authentication computing device 102 transmits an indicator of whether the authentication was successful or unsuccessful to one or more of merchant computing device 108 and issuer computing device 110.

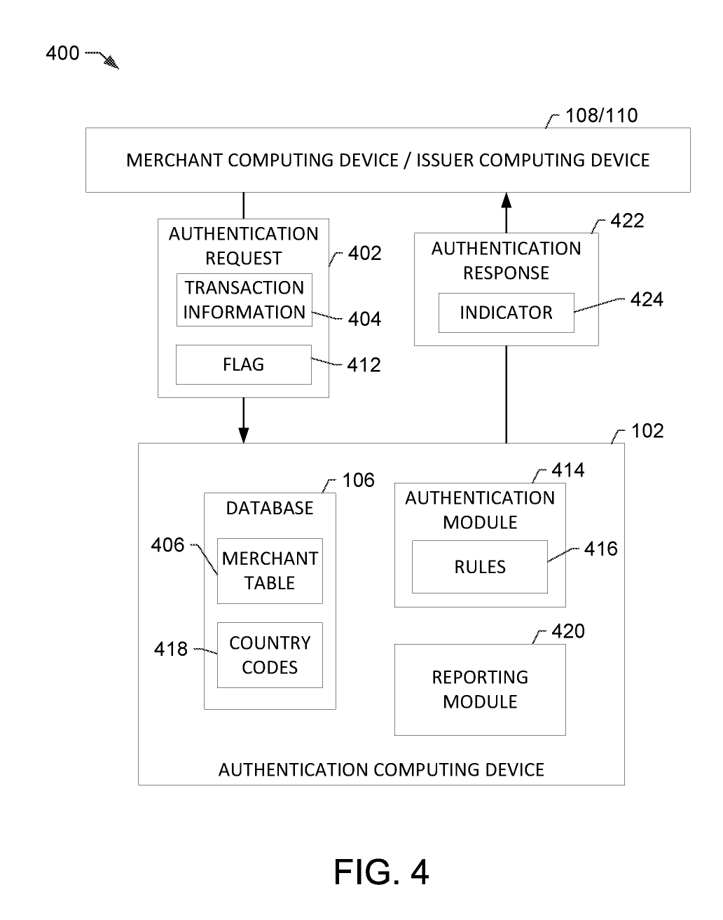

FIG. 4 is a diagram 400 illustrating the flow of information between components of secure identification system 100 (shown in FIG. 1). In the example embodiment, authentication computing device 102 is associated with an authentication service. As described above, the authentication service may be provided to merchants, merchant banks, and/or issuers by a transaction processing network and/or by another third party. As shown and described with respect to FIG. 1, authentication computing device 102 is in communication with database 106 and at least one merchant computing device 108 and/or issuer computing device 110. It should be understood that authentication computing device 102 may be in communication with fewer or more computing devices than illustrated in FIG. 4.

In the illustrated embodiment, authentication computing device 102 includes a plurality of modules configured to execute specific functions. More specifically, authentication computing device 102 includes an authentication module 414 and a reporting module 420. Authentication module 414 and reporting module 420 may include computer-executable instructions implemented on a processor (e.g., processor 305, shown in FIG. 3) of authentication computing device 102 to specifically execute the functions described herein. Moreover, in the illustrated embodiment, database 106 is shown as being integral to authentication computing device 102. Authentication computing device 102 may use database 106 to store, receive, retrieve, and/or otherwise access a lookup table or list 406 including a plurality of merchants, wherein the lookup table or list 406 indicates whether or not each merchant of the plurality of merchants is associated with providing software licenses and/or software-licensing services.

In one embodiment, each merchant is associated with one or more of merchant computing devices 108. In some cases, the grant of an initial software license may include the purchase or download of a temporary software license (e.g., a license that expires after a certain interval) or a “basic” software license (e.g., a license for a software package that includes some but not all premium software features). Merchant computing device 108 may record initial license expiry information indicating when the initial license is to expire or will no longer be valid, and/or when the licensee of the initial license may be eligible for a subsequent software license (e.g., upgrade to a premium license, the next installment of a recurring license, etc.). Merchant computing device 108 may prompt the user of the initial software license to initiate the transaction for the subsequent software license upon determining, using the initial license expiry information, that the initial software license has expired.

In the example embodiment, authentication module 414 receives an authentication request 402 associated with a transaction initiated in connection with a subsequent software license. Authentication module 14 may receive authentication request 402 from merchant computing device 108, issuer computing device 110, and/or a computing device associated with a merchant bank of the merchant. Authentication request 402 includes transaction information 404 associated with the transaction for which authentication is being requested. Transaction information 404 may include, for example, a merchant identifier, a transaction amount, a time and date stamp, location and/or device identifier (e.g., a device and/or location at which the transaction was initiated), and/or cardholder information. Authentication module 414 uses transaction information 404 to identify the merchant associated with the transaction. Additionally or alternatively, authentication module 414 may use other information contained in authentication request 402 to identify the merchant (e.g., a request origin identifier that identifies merchant computing device 108 associated with the merchant).

In one embodiment in which authentication request 402 is received from merchant computing device 108, authentication request 402 further includes a flag 412. Flag 412 may indicate that merchant computing device 108 has performed some measure of “in-house” authentication of user computing device 114 (shown in FIG. 1) at which the transaction is initiated. For example, merchant computing device 108 collects licensee information during the grant of an initial software license (not shown). Licensee information associates the particular software license granted to the machine (e.g., user computing device 114) and/or user of the machine to which access to the software is granted. Licensee information may include, for example, device information, payment card information, and/or digital wallet information. Device information may include information about the user computing device 114 used during the transaction, such as a unique hardware identifier, or an IP or MAC address associated with that user computing device 114. Payment card information may include information about the payment card or the cardholder (e.g., the user of the user computing device 114), such as a type of payment card used, payment credentials (e.g., payment card information), an expiration date of the payment card, or a name or a billing address of the cardholder. Digital wallet information may include information about a digital wallet used during the transaction, such as how the cardholder was authenticated into the digital wallet (e.g., an access code or method), whether the digital wallet has historically been used with the current user computing device 114, or whether the shipping address of the current transaction is a shipping address previously used with the digital wallet. In this example, flag 412 indicates that the merchant (associated with merchant computing device 108) has validated user credentials of the user associated with the transaction for the subsequent software license with user credentials associated with the initial software license (e.g., matching user credentials in transaction information 404 with user credentials in licensee information).

Authentication module 414 accesses merchant lookup table or list 406 to determine whether the merchant provides software licenses. If the merchant is on list 406, the authentication process proceeds. In some embodiments, if the merchant is not on list 406, the authentication process does not proceed and authentication computing device 102 does not authenticate the user of user computing device 114.

Authentication module 414 includes a rule-based engine 416 that includes a plurality of rules thereon directed the functionality of authentication module 414. For example, rule-based engine 416 may include rules directed to authenticating (successful) or not authenticating (unsuccessful) a transaction, when/if to send a step-up/3DS challenge, rules for communicating with other computing devices, card criteria, location criteria, etc. In some embodiments, at least some rules implemented by rule-based engine 416 may be changed, updated, set, and/or otherwise uniquely associated with particular merchants/merchant computing devices 108 and/or issuers/issuer computing device 110.

Authentication module 414 may authenticate or validate the cardholder initiating the purchase of the subsequent software license, as identified in authentication request 402 (e.g., in transaction information 404). Authentication module 414 determines that the card type being used to initiate the transaction has permission to make such a transaction, which may tend to favor authentication. Rule-based engine 416 may include rules that when the card type is associated with appropriate transaction permissions, card criteria are satisfied. Authentication module 414 also accesses a list of high-risk country codes 418 at database 406 to determine that an IP address of user computing device 114 (or another device identifier) is not associated with a high-risk country. Rule-based engine 416 may include rules that when a location of user computing device 114 is not associated with a high-risk country, location criteria are satisfied. Authentication module 414 may additionally or alternatively perform any other authentications or validations according to rules in rule-based engine 416. For example, authentication module 414 may parse transaction data 404 to determine a transaction time associated with the transaction. Rule-based engine 416 may include a rule that a transaction being initiated at an unusually late time (e.g., between 12 PM and 5 AM, adjusted for the local time of the user computing device) will not be authenticated or will weigh against being authenticated. As another example, authentication module 414 may determine, based on one or more data elements of transaction data 404, that a proxy server was used to route the transaction activity. Accordingly, authentication module 414 may determine that such a transaction does not meet location criteria as determining the actual origin of the activity is difficult or impossible.

Authentication module 414 may use rule-based engine 416 to determine whether certain matches or authentications satisfy “authentication successful” criteria (e.g., the identity of the cardholder is successfully authenticated and/or the transaction is successfully authenticated). In one embodiment, when card criteria and location criteria are satisfied, “authentication successful” criteria are satisfied. In certain embodiments, when one or both of card criteria and location criteria are not satisfied, “authentication unsuccessful” criteria are satisfied (and/or “authentication successful” criteria are not satisfied).

Based on the output from authentication module 414 (e.g., an “authentication successful” or “authentication unsuccessful” output), reporting module 420 prepares an authentication response 422 for transmission. Authentication response 422 includes an indicator 424 of the output from authentication module 414. For example, indicator 424 may indicate a successful authentication of the transaction (e.g., successful authentication of the identity of the user of user computing device 114 as the cardholder associated with the initial software license). The indicator 424 may indicate an unsuccessful authentication of the transaction.

Reporting module 420 may then transmit authentication response 422 to merchant computing device 108 (and/or issuer computing device 110). If indicator 424 indicates a successful authentication and merchant computing device 108 requested the authentication services of authentication computing device 102, merchant computing device 108 may then proceed with the authorization process for the transaction, described above. If indicator 424 indicates a successful authentication and issuer computing device 110 requested the authentication services of authentication computing device 102, issuer computing device 110 may then proceed with the authorization process for the transaction. In the example embodiment, merchant computing device 108 (and/or issuer computing device 110) may bypass any additional authentication procedure (e.g., 3-D Secure® authentication or “step-up” authentication) based upon the successful authentication by authentication module 414. Accordingly, cardholder inconveniences may be reduced and fewer transactions may be abandoned.

In some embodiments, if the initial authentication using transaction information 404 was unsuccessful, authentication module 414 transmits (or otherwise causes display of) a prompt to the user of user computing device 114 to enter additional authentication information. In certain embodiments, authentication computing device 102 may be in direct communication with user computing device 114 and accordingly may transmit the prompt directly to user computing device 114 for display. In other embodiments, in which authentication computing device 102 is not in direct communication with user computing device 114, authentication module 514 may transmit the prompt to merchant computing device 108 and/or issuer computing device 110 for subsequent transmittal to user computing device 114. Additional authentication information may include, for example, a password, a response to a security question, and/or any other information suitable for authentication of the cardholder. In other embodiments, authentication module 414 performs no additional authentication.

Authentication computing device 102 may alternatively transmit authentication response 422 with indicator 424 indicating an unsuccessful authentication. Authentication response 422 may also indicate to merchant computing device 108 (and/or issuer computing device 110) the results of any and all authentication processes performed. If merchant computing device 108 requested the authentication services of authentication computing device 102, merchant computing device 108 may process authentication response 422 and determine whether to decline the transaction or proceed with the authorization process for the transaction. If merchant computing device 108 determines to proceed with the authorization process for the transaction, merchant computing device 108 transmits an authorization request message to issuer computing device 110. The authorization request message may additionally include indicator 424 and/or any other results of the authentication processes performed by authentication computing device 102. Issuer computing device 110 may refuse to authorize the transaction based on the unsuccessful authentication. If issuer computing device 110 requested the authentication services of authentication computing device 102, issuer computing device 110 receives authentication response 422 directly and may determine whether to decline the transaction or proceed with the authorization process.

In some embodiments, reporting module 420 transmits authentication response 422 (whether the authentication was successful or unsuccessful) to merchant and/or issuer computing device 108, 110 via an extension message to the 3DS protocol. For example, reporting module 420 may provide indicator 424 by embedding an XML-formatted message as a 3DS extension during the authentication process. In some embodiments, reporting module 420 may share, in authentication response 422, individual risk-based data elements used to determine whether the authentication was successful or unsuccessful, such as whether card and/or location criteria were or were not satisfied. In some embodiments, reporting module 420 also transmits flag 412 with authentication response 422. For example, reporting module 420 may transmit authentication repose 420 including flag 412 to issuer computing device 110 as a further data element to support user authentication.

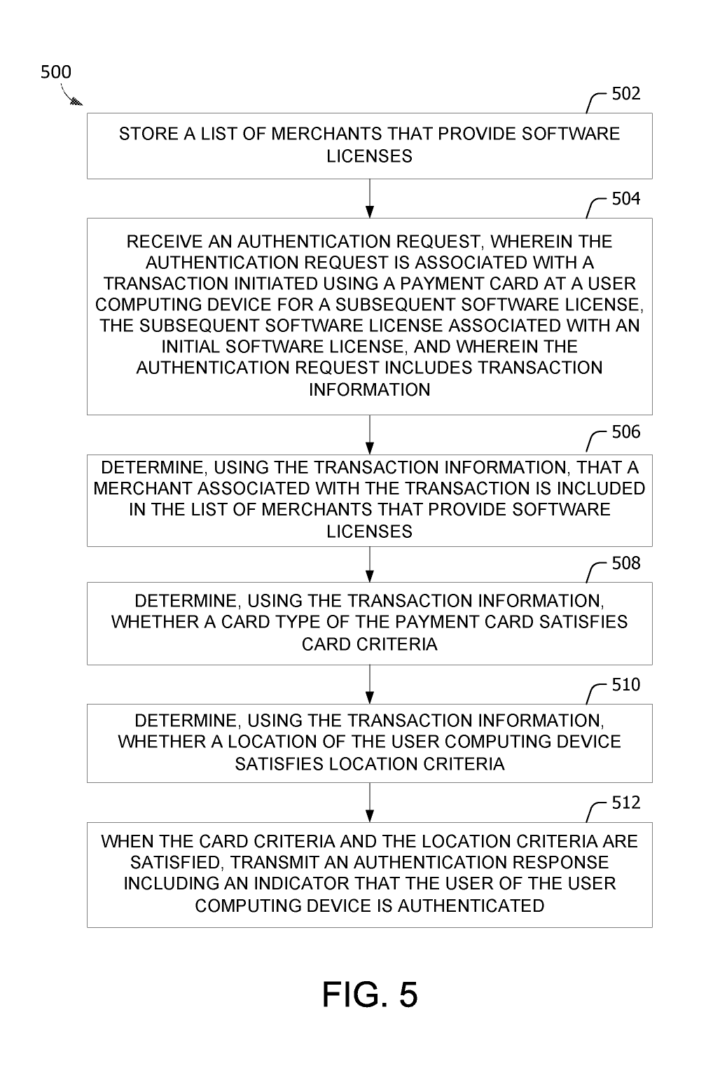

FIG. 5 is an example method 500 of authenticating a user of a user computing device using software license information using, for example, secure identification system 100 (shown in FIG. 1). For example, at least some of the steps of method 500 may be performed using authentication computing device 102 (also shown in FIG. 1).

In the example embodiment, method 500 includes storing 502 a list of merchants that provide software licenses (e.g., lookup table/list 406, shown in FIG. 4). Method 500 also includes receiving 504 an authentication request (e.g., authentication request 402, also shown in FIG. 4). The authentication request is with a transaction initiated using a payment card at a user computing device (e.g., user computing device 114, shown in FIG. 1) for a subsequent software license. The subsequent software license is associated with an initial software license. The authentication request includes transaction information (e.g., transaction information 404, shown in FIG. 4). Method 500 further includes determining 506, using the transaction information, that a merchant associated with the transaction is included in the list of merchants that provide software licenses.

Method 500 further includes determining 508, using the transaction information, whether a card type of the payment card satisfies card criteria, and determining 510, using the transaction information, whether a location of the user computing device satisfies location criteria. Method 500 still further includes, when the card criteria and the location criteria are satisfied, transmitting 512 an authentication response (e.g., authentication response 422) including an indicator (e.g., indicator 424, both shown in FIG. 4) that the user of the user computing device is authenticated

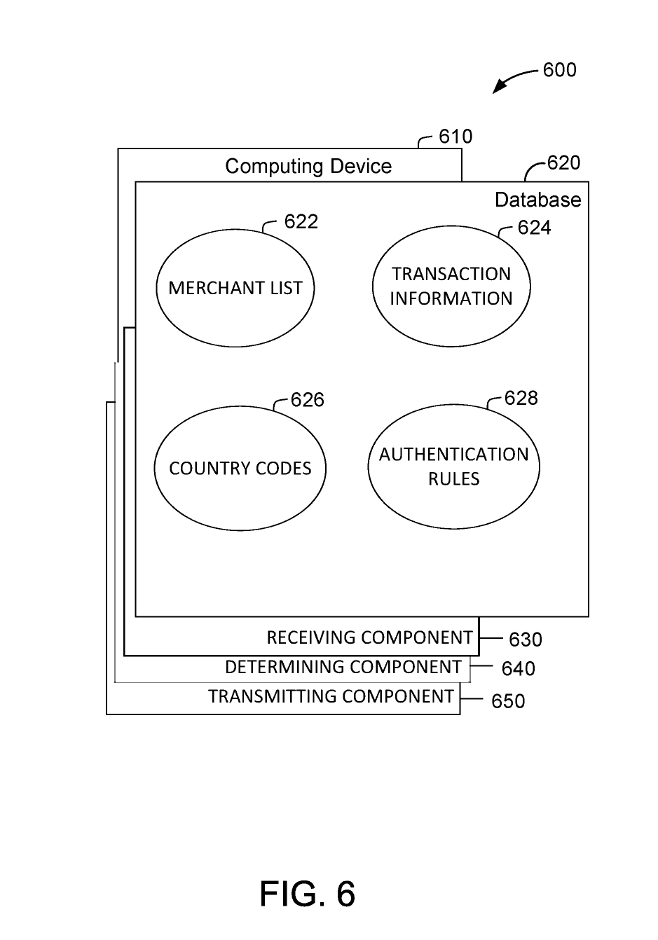

FIG. 6 shows an example configuration 600 of a computing device 610 including a database 620, along with other related computing components, that may be used to authenticate an identity of a user of a user computing device, using software license information. In some embodiments, computing device 610 is similar to authentication computing device 102 (shown in FIG. 1). In the example embodiment, database 620 includes a merchant list or table 622, transaction information 624 associated with a transaction initiated using a payment card at a user computing device for a subsequent software license, country codes 626 associated with high-risk countries, and authentication rules 628 for determining successful and unsuccessful authentication outcomes. Database 620 may include more or less information, including other information used in authentication services as described elsewhere herein. In some embodiments, database 620 is similar to database 106 (shown in FIG. 1). Database 620 is coupled to several separate components within computing device 610, which perform specific tasks.

In particular, computing device 610 includes a receiving component 630 configured to receive an authentication request. The authentication request is associated with a transaction initiated using a payment card at a user computing device for a subsequent software license, and the subsequent software license is associated with the initial software license. The authentication request includes transaction information.

Computing device 610 also includes a determining component 640 configured to determine that a merchant associated with the transaction is included in the list of merchants 622 that provide software licenses. Determining component 640 is further configured to determine whether a card type of the payment card satisfies card criteria (e.g., part of authentication rules 628), and determine whether a location of the user computing device satisfies location criteria (e.g., part of authentication rules 628). Determining component 640 accesses at least transaction information 624 to make such determinations.

Computing device 610 further includes a transmitting component 650. Transmitting component 650 is configured to transmit an authentication response including an indicator that the user of the user computing device is authenticated, when the card criteria and the location criteria are satisfied.

As will be appreciated based on the foregoing specification, the above-described embodiments of the disclosure may be implemented using computer programming or engineering techniques including computer software, firmware, hardware or any combination or subset thereof, wherein the technical effect is a identity authentication system specifically configured to perform fraud analysis of payment card transactions associated with software licenses. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An authentication computing device for authenticating a user of a user computing device using software license information, said authentication computing device including a processor in communication with a memory, said processor programmed to:
store a list of merchants that provide software licenses;
receive an authentication request, wherein the authentication request is associated with a transaction initiated using a payment card at the user computing device for a subsequent software license, the subsequent software license associated with an initial software license, and wherein the authentication request includes transaction information;
determine, using the transaction information, that a merchant associated with the transaction is included in the list of merchants that provide software licenses;
determine, using the transaction information, whether a card type of the payment card satisfies card criteria;
determine, using the transaction information, whether a location of the user computing device satisfies location criteria;
when the card criteria and the location criteria are satisfied, transmit an authentication response including an indicator that the user of the user computing device is authenticated.

2. The authentication computing device of claim 1, wherein to satisfy the card criteria, the card type must have permission to make the transaction for the subsequent software license.

3. The authentication computing device of claim 1, wherein to satisfy the location criteria, an IP address of the user computing device must not be associated with a high-risk country.

4. The authentication computing device of claim 1, wherein said processor is further programmed to:
receive the authentication request from a merchant computing device associated with the merchant; and
transmit the authentication response to the merchant computing device.

5. The authentication computing device of claim 1, wherein said processor is further programmed to:
receive the authentication request from an issuer computing device associated with the payment card; and
transmit the authentication response to the issuer computing device.

6. The authentication computing device of claim 1, wherein the transaction information includes a flag indicating that the merchant has validated user credentials of the user associated with the transaction for the subsequent software license with user credentials associated with the initial software license, and wherein said processor is further configured to transmit the authentication response including the flag to an issuer computing device associated with the payment card.

7. The authentication computing device of claim 1, wherein said processor is further programmed to, when at least one of the card criteria and the location criteria are not satisfied, transmit the authentication response including an indicator that the user of the user computing device is not authenticated.

8. A computer-implemented method for authenticating a user of a user computing device using software license information, said method implemented using an authentication computer device including a processor and a memory, said method comprising:
storing a list of merchants that provide software licenses;
receiving an authentication request, wherein the authentication request is associated with a transaction initiated using a payment card at the user computing device for a subsequent software license, the subsequent software license associated with an initial software license, and wherein the authentication request includes transaction information;
determining, using the transaction information, that a merchant associated with the transaction is included in the list of merchants that provide software licenses;
determining, using the transaction information, whether a card type of the payment card satisfies card criteria;
determining, using the transaction information, whether a location of the user computing device satisfies location criteria;
when the card criteria and the location criteria are satisfied, transmitting an authentication response including an indicator that the user of the user computing device is authenticated.

9. The method of claim 8, wherein said determining whether a card type of the payment card satisfies card criteria comprises determining that the card type has permission to make the transaction for the subsequent software license.

10. The method of claim 8, wherein said determining whether a location of the user computing device satisfies location criteria comprises determining that an IP address of the user computing device is not associated with a high-risk country.

11. The method of claim 8 further comprising:
receiving the authentication request from a merchant computing device associated with the merchant; and
transmitting the authentication response to the merchant computing device.

12. The method of claim 8 further comprising:
receiving the authentication request from an issuer computing device associated with the payment card; and
transmitting the authentication response to the issuer computing device.

13. The method of claim 8, wherein the transaction information includes a flag indicating that the merchant has validated user credentials of the user associated with the transaction for the subsequent software license with user credentials associated with the initial software license, and wherein said processor is further configured to transmit the authentication response including the flag to an issuer computing device associated with the payment card.

14. The method of claim 8 further comprising, when at least one of the card criteria and the location criteria are not satisfied, transmitting the authentication response including an indicator that the user of the user computing device is not authenticated.

15. At least one non-transitory computer-readable storage media having computer-executable instructions embodied thereon, for authenticating a user of a user computing device using software license information, wherein when executed by at least one processor, the computer-executable instructions cause the processor to:
store a list of merchants that provide software licenses;
receive an authentication request, wherein the authentication request is associated with a transaction initiated using a payment card at the user computing device for a subsequent software license, the subsequent software license associated with an initial software license, and wherein the authentication request includes transaction information;
determine, using the transaction information, that a merchant associated with the transaction is included in the list of merchants that provide software licenses;
determine, using the transaction information, whether a card type of the payment card satisfies card criteria;
determine, using the transaction information, whether a location of the user computing device satisfies location criteria;
when the card criteria and the location criteria are satisfied, transmit an authentication response including an indicator that the user of the user computing device is authenticated.

16. The computer-readable storage media of claim 15, wherein to satisfy the card criteria, the card type must be associated with a permission to make the transaction of the subsequent software license.

17. The computer-readable storage media of claim 15, wherein to satisfy the location criteria, an IP address of the user computing device must not be associated with a high-risk country.

18. The computer-readable storage media of claim 15, wherein the computer-executable instructions cause the processor to:
receive the authentication request from at least one of a merchant computing device associated with the merchant and an issuer computing device associated with the payment card; and
transmit the authentication response to the at least one of the merchant computing device and the issuer computing device.

19. The computer-readable storage media of claim 15, wherein the transaction information includes a flag indicating that the merchant has validated user credentials of the user associated with the transaction for the subsequent software license with user credentials associated with the initial software license, and wherein the computer-executable instructions cause the processor to transmit the authentication response including the flag to an issuer computing device associated with the payment card.

20. The computer-readable storage media of claim 15, wherein the computer-executable instructions cause the processor to, when at least one of the card criteria and the location criteria are not satisfied, transmit the authentication response including an indicator that the user of the user computing device is not authenticated.
